(19) United States
(12) Patent Application Publication
(10) Pub. No.: US 2014/0149960 A1
(43) Pub. Date: May 29, 2014

(54) COMPUTING DEVICE AND METHOD FOR CHECKING WIRING DIAGRAMS OF PCB

(71) Applicants: Hon Hai Precision Industry Co., Ltd., New Taipei (TW); Hong Fu Jin Precision Industry (ShenZhen) Co., Ltd., Shenzhen (CN)

(72) Inventors: YA-LING HUANG, Shenzhen (CN); MING WEI, Shenzhen (CN); CHIA-NAN PAI, Tu-Cheng (TW); SHOU-KUO HSU, Tu-Cheng (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/051,503

(22) Filed: Oct. 11, 2013

(30) Foreign Application Priority Data
Nov. 27, 2012 (CN) 2012104906637

(51) Int. Cl. G06F 17/50

(52) U.S. Cl. CPC G06F 17/50
USPC 716/137

(57) ABSTRACT

In a method for checking wiring diagrams, one element is selected from a first printed circuit board (PCB) file. An element corresponding to the selected element in a second PCB file is searched according to information of the selected element, then the information is recorded into a different element list of the first PCB file, when the second PCB file does not have a corresponding element. The information is recorded into a same element list, when the second PCB file has a corresponding element and the corresponding element has the same information with the element in the first PCB file. The second PCB file and the same element list are compared to locate elements which are included in the second PCB file but not included in the same element list, and the information of the located elements is recorded into a different element list of the second PCB file.

### BACKGROUND

1. Technical Field

Embodiments of the present disclosure relate to wiring design, and more particularly to a computing device and a method for checking wiring diagrams of a printed circuit board (PCB).

2. Description of Related Art

Usually, different designers may collaborate for wiring design of printed circuit boards (PCB). When the wiring design is modified by one designer, the modifications need to be notified to other designers. If there is too many modifications, it is very troublesome for each designer to keep track of all the modifications. Existing PCB design software does not alert designers of any modification in the wiring diagram of a PCB.

### BRIEF DESCRIPTION OF THE DRAWINGS

FIG. 1 is a block diagram of one embodiment of a computing device including a wiring check system.

FIG. 2 is a block diagram of one embodiment of function modules of the wiring check system in FIG. 1.

FIGS. 3A to 3D illustrate a flowchart of one embodiment of a method for checking wiring diagrams of a PCB.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

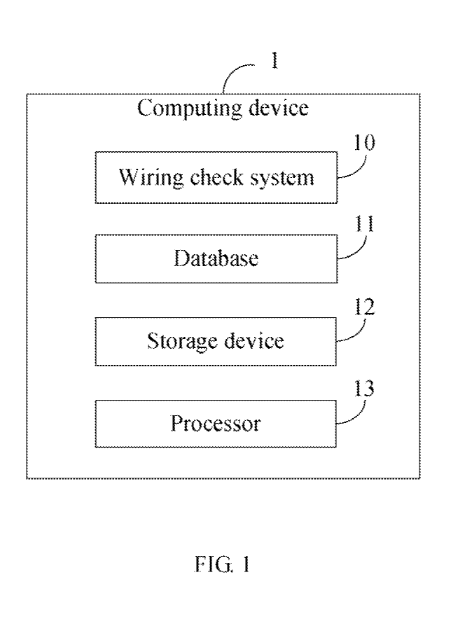

FIG. 1 is a block diagram of one embodiment of a computing device 1 including a wiring check system 10. The computing device 1 may be a computer, a server, or a personal digital assistant (PDA), for example. The computing device 1 may further include components such as a database 11, a storage device 12, and a processor 13. One skilled in the art would recognize that the computing device 1 may be configured in a number of other ways and may include other or different components.

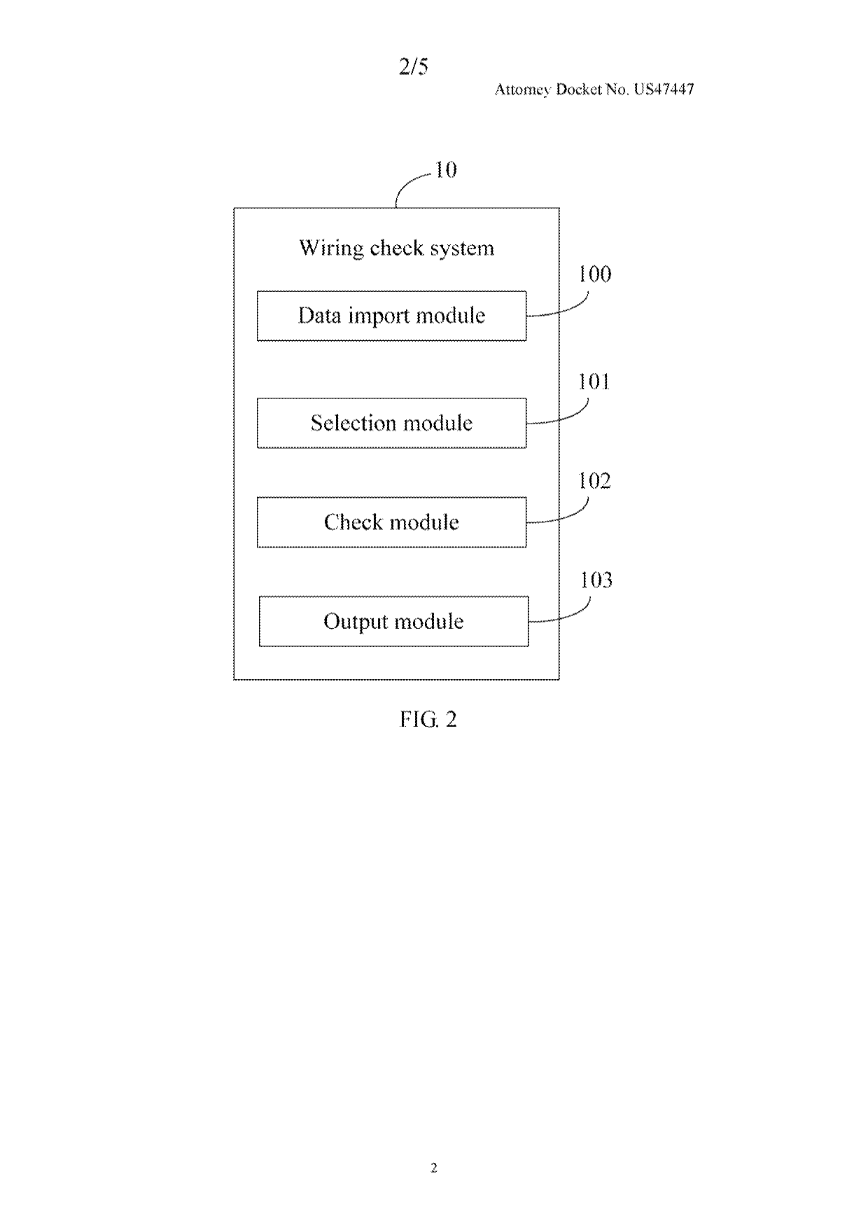

The wiring check system 10 includes a number of function modules (depicted in FIG. 2). The function modules may include computerized code in the form of one or more programs, which have functions of automatically checking modifications between two wiring diagrams.

The database 11 stores printed circuit board (PCB) files. Each of the PCB files includes a wiring diagram of a PCB and data relating to the wiring diagram. The wiring diagram is a simplified conventional pictorial representation of an electrical circuit, in which multiple electrical components are wired together using transmission lines. The data relating to the wiring diagram includes identification information and basic information of the components and the transmission lines. The identification information includes, names, identifiers (ID), and so on. The basic information of the components includes types, coordinates data, pin information, layers, and so on, and the basic information of the transmission lines includes paths, line lengths, line widths, line spaces, and so on.

The storage device 12 may include some type(s) of computer-readable storage medium, such as a hard disk drive, a compact disc, a digital video disc, or a tape drive. The storage device 12 stores the computerized code of the function modules of the wiring check system 10 for execution by the processor 13.

The processor 13 may include a processor, a microprocessor, an application-specific integrated circuit (ASIC), and a field programmable gate array, (FPGA) for example. The processor 13 may execute the computerized code of the function modules of the wiring check system 10 to realize the functions of the wiring check system 10.

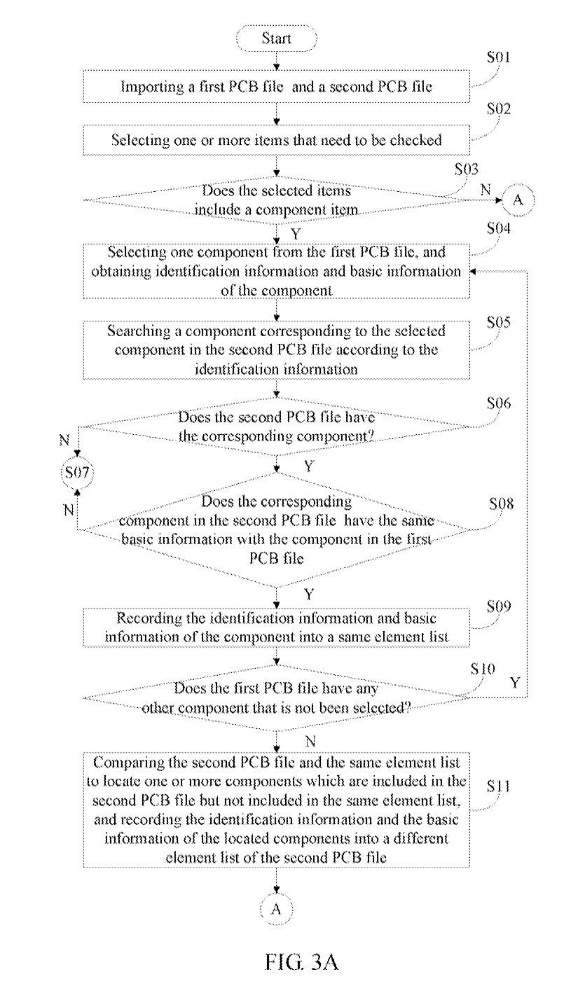

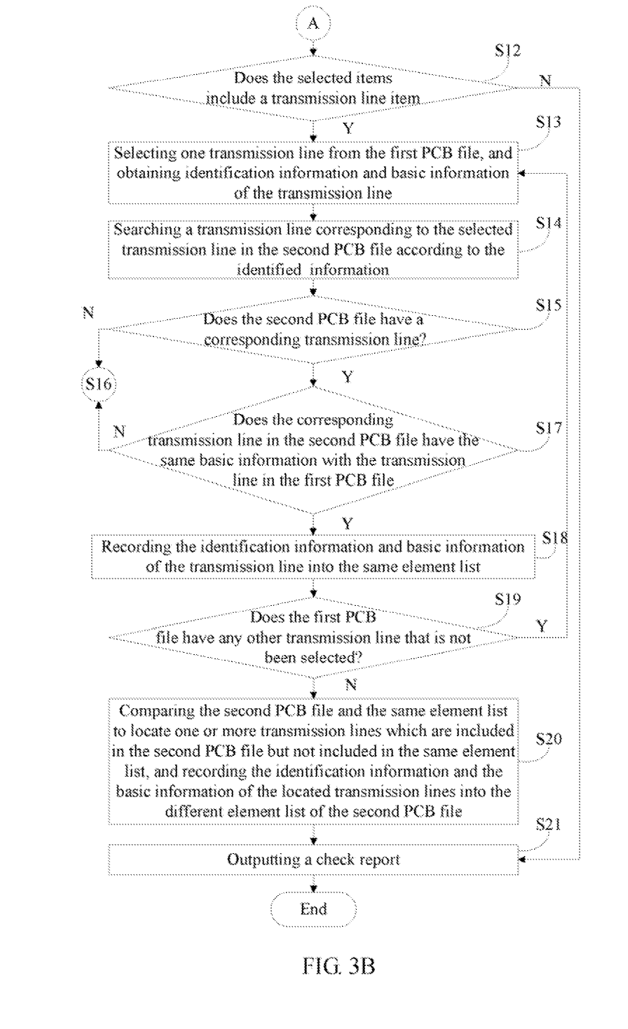

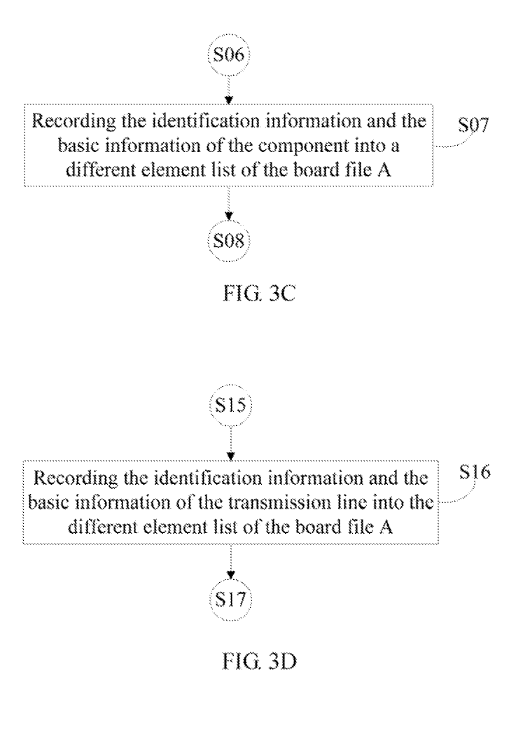

FIG. 2 is a block diagram of one embodiment of the function modules of the wiring check system 10. In one embodiment, the wiring check system 10 may include a data import module 100, a selection module 101, a check module 102, and an output module 103. The function modules 100-103 provide at least the functions needed to execute the steps illustrated in FIGS. 3A to 3D.

FIGS. 3A to 3D illustrate a flowchart of one embodiment of a method for checking wiring diagrams of a PCB. Depending on the embodiment, additional steps may be added, others removed, and the ordering of the steps may be changed.

In step S01, the data import module 100 imports a first PCB file and a second PCB file from the database 11. Each of the first PCB file and the PCB file includes a wiring diagram, and data relating to the wiring diagram. The data relating to the wiring diagram includes identification information and basic information of components and the transmission lines in the wiring diagram. In one embodiment, the wiring diagrams in the first PCB file and the second PCB file are different versions for a same PCB.

In step S02, the selection module 102 provides a user interface for a user selecting one or more items that need to be checked. The items include, for example, a component item and a transmission line item.

In step S03, the check module 102 checks whether the selected items include a component item. Steps S04 to S11 are implemented when the selected items include a component item. Otherwise, step S12 is implemented when the selected items does not include a component item.

In step S04, the check module 102 selects one element belonging to the component item, namely one component, from the first PCB file, and obtains identification information and basic information of the selected component from the first PCB file. As mentioned above, the identification information includes, for example, a name and/or an ID of the selected component, and the basic information includes, types, coordinates data, pin information, and layers of the selected component, etc.

In step S05, the check module 102 searches a component corresponding to the identification information in the second PCB file. That is, the check module 102 checks the second PCB file to search a component which has the same identification information with the selected component in the first PCB file.

In step S06, the check module 102 checks whether the second PCB file has a corresponding component. Step S07 (see FIG. 3C) is implemented when the second PCB file does not have the corresponding component. Otherwise, step S08 is implemented when the second PCB file has the corresponding component.

In step S07, the check module 102 records the identification information and the basic information of the selected component into a different element list of the first PCB file.

In step S08, the check module 102 checks whether the corresponding component in the second PCB file has the same basic information with the selected component in the first PCB file. Step S07 (see FIG. 3C) is implemented when the corresponding component in the second PCB file has different basic information with the selected component in the first PCB file. Otherwise, step S09 is implemented when the corresponding component in the second PCB file have the same basic information with the selected component in the first PCB file.

In step S09, the check module 102 records the identification information and basic information of the selected component into a same element list.

In step S10, the check module 102 checks whether the first PCB file have any other component that is not selected. When all the components in the PCB file have been selected, step S11 is implemented. Otherwise, until all the components in the PCB file have been selected, the procedure returns to step S04.

In step S11, the check module 102 compares the second PCB file and the same element list to locate one or more components which are included in the second PCB file but not included in the same element list, and records the identification information and the basic information of the located components into a different element list of the second PCB file.

In step S12 (FIG. 3B), the check module 102 checks whether the selected items include a transmission line item.

In step S13, the check module 102 selects one element belonging to the transmission line item, namely selects one transmission line, from the first PCB file, and obtaining identification information and basic information of the selected transmission line. As mentioned, the identification information includes, a name and/or an ID of the selected transmission line, etc. and the basic information includes paths, line lengths, line widths, and line spaces of the selected transmission line.

In step S14, the check module 102 searches a transmission line corresponding to the identification information in the second PCB file. That is, the check module 102 checks the second PCB file to search a transmission line which has the same identification information with the selected transmission line in the first PCB file.

In step S15, the check module 102 checks whether the second PCB file has a corresponding transmission line. Step S16 (see FIG. 3D) is implemented when the second PCB file does not have the transmission line. Otherwise, step S17 is implemented when the second PCB file has the corresponding transmission line.

In step S16, the check module 102 records the identification information and the basic information of the selected transmission line into the different element list of the first PCB file.

In step S17, the check module 102 checks whether the corresponding transmission line in the second PCB file have the same basic information with the selected transmission line in the first PCB file. Step S16 (see FIG. 3D) is implemented when the corresponding component in the second PCB file has different basic information with the selected transmission line in the first PCB file. Otherwise, step S18 is implemented when the corresponding component in the second PCB file has the same basic information with the selected transmission line in the first PCB file.

In step S18, the check module 102 records the identification information and basic information of the selected transmission line in the same element list.

In step S19, the check module 102 checks whether the first PCB file has any other transmission line that is not selected. When all the transmission lines in the PCB file have been selected, step S20 is implemented. Otherwise, until all the transmission lines in the PCB file have been selected, the procedure returns to step S13.

In step S20, the check module 102 compares the second PCB file and the same element list to locate one or more transmission lines which are included in the second PCB file but not included in the same element list, and records the identification information and the basic information of the located transmission lines into the different element list of the second PCB file.

In step S21, the output module 103 outputs a check report which includes the different element list of the first PCB file, the different element list of the second PCB file, and the same element list.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for checking wiring diagrams in a printed circuit board (PCB), the method being executed by at least one processor of a computing device and comprising:
importing a first PCB file and a second PCB file from a database;
selecting one or more items that need to be checked from the first PCB file;
selecting one element belonging to a selected item from the first PCB file, and obtaining identification information and basic information of the selected element from the first PCB file;
searching an element corresponding to the identification information in the second PCB file;
recording the identification information and the basic information of the selected element into a different element list of the first PCB file, when the second PCB file does not have a corresponding element;
recording the identification information and the basic information of the selected element into a same element list, when the second PCB file has a corresponding element and the corresponding element has the same basic information with the selected element in the first PCB file;
comparing the second PCB file and the same element list to locate one or more elements which are included in the second PCB file but not included in the same element list, when all the elements in the PCB file have been selected;
recording the identification information and the basic information of the located elements into a different element list of the second PCB file; and
outputting a check report comprising the different element list of the first PCB file, the different element list of the second PCB file, and the same element list.

2. The method according to claim 1, wherein the items comprise a component item and a transmission line item.

3. The method according to claim 2, wherein the selected item is the component item, and the selected element is one of components in the first PCB file.

4. The method according to claim 3, wherein the identification information comprises a name and/or an identifier of the component, and the basic information comprises types, coordinates data, pin information, and layers of the component.

5. The method according to claim 2, wherein the selected item is the transmission line item, and the selected element is one of transmission lines in the first PCB file.

6. The method according to claim 5, wherein the identification information comprises a name and/or an identifier of the transmission line, and the basic information comprises a path, a line length, a line width, and a line space of the transmission line.

7. A computing device, comprising:
a non-transitory storage medium;
at least one processor; and
one or more modules that are stored in the non-transitory storage medium, and are executed by the at least one processor, the one or more modules comprising instructions to:
import a first printed circuit board (PCB) file and a second PCB file from a database;
select one or more items that need to be checked from the first PCB file;
select one element belonging to a selected item from the first PCB file, and obtain identification information and basic information of the selected element from the first PCB file;
search an element corresponding to the identification information in the second PCB file;
record the identification information and the basic information of the selected element into a different element list of the first PCB file, when the second PCB file does not have a corresponding element;
record the identification information and the basic information of the selected element into a same element list, when the second PCB file has a corresponding element and the corresponding element has the same basic information with the selected element in the first PCB file;
compare the second PCB file and the same element list to locate one or more elements which are included in the second PCB file but not included in the same element list, when all the elements in the PCB file have been selected;
record the identification information and the basic information of the located elements into a different element list of the second PCB file; and
output a check report comprising the different element list of the first PCB file, the different element list of the second PCB file, and the same element list.

8. The computing device according to claim 7, wherein the items comprise a component item and a transmission line item.

9. The computing device according to claim 8, wherein the selected item is the component item, and the selected element is one of components in the first PCB file.

10. The computing device according to claim 9, wherein the identification information comprises a name and/or an identifier of the component, and the basic information comprises types, coordinates data, pin information, and layers of the component.

11. The computing device according to claim 8, wherein the selected item is the transmission line item, and the selected element is one of transmission lines in the first PCB file.

12. The computing device according to claim 11, wherein the identification information comprises a name and/or an identifier of the transmission line, and the basic information comprises a path, a line length, a line width, and a line space of the transmission line.

13. A non-transitory storage medium having stored thereon instructions that, when executed by a processor of a computing device, causes the processor to perform a method for checking wiring diagrams in a printed circuit board (PCB), comprising:
importing a first PCB file and a second PCB file from a database;
selecting one or more items that need to be checked from the first PCB file;
selecting one element belonging to a selected item from the first PCB file, and obtaining identification information and basic information of the selected element from the first PCB file;
searching an element corresponding to the identification information in the second PCB file;
recording the identification information and the basic information of the selected element into a different element list of the first PCB file, when the second PCB file does not have a corresponding element;
recording the identification information and the basic information of the selected element into a same element list, when the second PCB file has a corresponding element and the corresponding element has the same basic information with the selected element in the first PCB file;
comparing the second PCB file and the same element list to locate one or more elements which are included in the second PCB file but not included in the same element list, when all the elements in the PCB file have been selected;
recording the identification information and the basic information of the located elements into a different element list of the second PCB file; and
outputting a check report comprising the different element list of the first PCB file, the different element list of the second PCB file, and the same element list.

14. The non-transitory storage medium according to claim 13, wherein the items comprise a component item and a transmission line item.

15. The non-transitory storage medium according to claim 14, wherein the selected item is the component item, and the selected element is one of components in the first PCB file.

16. The non-transitory storage medium according to claim 15, wherein the identification information comprises a name and/or an identifier of the component, and the basic information comprises types, coordinates data, pin information, and layers of the component.

17. The non-transitory storage medium according to claim 14, wherein the selected item is the transmission line item, and the selected element is one of transmission lines in the first PCB file.

18. The non-transitory storage medium according to claim 17, wherein the identification information comprises a name and/or an identifier of the transmission line, and the basic information comprises a path, a line length, a line width, and a line space of the transmission line.
